(19) United States
(12) Patent Application Publication
(10) Pub. No.: US 2026/0036505 A1
(43) Pub. Date: Feb. 5, 2026

(54) RHEOMETERS SUITABLE FOR THERMOSETTING RESINS

(71) Applicant: CHANGZHOU UNIVERSITY, Changzhou (CN)

(72) Inventors: Huayong LIAO, Changzhou (CN); Jinyan RAN, Changzhou (CN); Mingju LI, Changzhou (CN); Shuai ZHANG, Changzhou (CN); Chunlin LIU, Changzhou (CN); Guoliang TAO, Changzhou (CN)

(73) Assignee: CHANGZHOU UNIVERSITY, Changzhou (CN)

(21) Appl. No.: 19/329,522

(22) Filed: Sep. 15, 2025

Related U.S. Application Data
(63) Continuation-in-part of application No. PCT/CN2023/123933, filed on Oct. 11, 2023.

(30) Foreign Application Priority Data
Mar. 13, 2023 (CN) 202310238413.2

(51) Int. Cl. G01N 11/14; G01N 11/04

(52) U.S. Cl. CPC G01N 11/14; G01N 11/04

(57) ABSTRACT

A rheometer suitable for a thermosetting resin is provided, including a housing, a first piston cylinder disposed inside the housing, and a second piston cylinder connected to the first piston cylinder via a connecting rod. A capillary tube is mounted at a middle portion of a bottom of the second piston cylinder, and a container is mounted at an outlet of the capillary tube. A bottom end of the connecting rod is provided with a first force sensor for measuring a first force transmitted from a sample in the first piston cylinder to the lower piston; a rotating element is mounted inside the first piston cylinder, the rotating element is provided with a torque sensor and a rotational speed sensor for measuring a torque of the sample relative to the rotating element and an angular velocity of the rotating element, thereby determining rheological parameters of the sample during curing process.

### CROSS-REFERENCE TO RELATED APPLICATIONS

This application is a continuation-in-part application of International Application No. PCT/CN2023/123933, filed on Oct. 11, 2023, which claims priority to Chinese Patent Application No. 202310238413.2, filed on Mar. 13, 2023, the entire contents of each of which are incorporated herein by reference.

### TECHNICAL FIELD

The present disclosure generally relates to the technical field of rheological testing, and in particular to a rheometer suitable for a thermosetting resin.

### BACKGROUND

A conventional rotational rheometer can be used to measure rheological properties of a material, such as viscosity and modulus. A conventional rotational rheometer is generally suitable for measuring rheological properties of a thermoplastic material. However, if a material to be measured undergoes a curing or cross-linking chemical reaction during measurement, some problems may occur. For example, the material may undergo volume expansion, and performance parameters such as viscosity, modulus, or hardness may increase sharply. At this time, a large normal stress is applied to the rheometer, which may cause damage to the instrument. For example, a phenolic resin that is now commonly used may undergo rapid curing in a parallel plate fixture of a rotational rheometer. Two parallel plates of the parallel plate fixture are subjected to a large axial thrust (i.e., normal stress). This is obviously not conducive to measurement and protection of the instrument. Moreover, once the material to be measured undergoes such curing and cross-linking reactions, the measurement process may be forced to stop, which affects the measurement. Thus, rheological parameters during the curing process of the resin cannot be obtained accurately.

Therefore, it is desirable to provide a rheometer suitable for a thermosetting resin. The rheometer can solve the problem that accurate rheological parameters during the curing process of the resin cannot be obtained in the prior art, thereby expanding a measurement range and optimizing a measurement result.

### SUMMARY

One or more embodiments of the present disclosure provide a rheometer applicable to a thermosetting resin. The rheometer includes a housing, a first piston cylinder disposed inside the housing, and a second piston cylinder connected to the first piston cylinder via a connecting rod; wherein a capillary tube is mounted at a middle portion of a bottom of the second piston cylinder, and a container is mounted at an outlet of the capillary tube; a lower end of the first piston cylinder is provided with an upper piston, and an upper end of the second piston cylinder is provided with a lower piston; an upper end of the connecting rod is fixedly connected to the upper piston, and a lower end of the connecting rod is fixedly connected to the lower piston, wherein the connecting rod is configured to drive the lower piston to move downward; a bottom end of the connecting rod is provided with a first force sensor for measuring a first force transmitted from a sample in the first piston cylinder to the lower piston; a flow sensor is mounted at an inlet connecting the capillary tube to the bottom of the second piston cylinder, and the flow sensor is configured to measure a flow rate of a solution extruded from the capillary tube; a rotating element is mounted inside the first piston cylinder, wherein the rotating element is provided with a torque sensor and a rotational speed sensor, the torque sensor is configured to measure a torque of the sample in the first piston cylinder relative to the rotating element, and the rotational speed sensor is configured to measure an angular velocity of the rotating element; and rheological parameters of the sample during a curing process are determined based on the first force transmitted to the lower piston, the flow rate of the solution extruded from the capillary tube, the torque, and the angular velocity.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a schematic diagram illustrating a structure of a rheometer according to some embodiments of the present disclosure;

FIG. 2 is a schematic diagram illustrating a viscosity-angular frequency rheological curve of a sample according to some embodiments of the present disclosure;

FIG. 3 is a schematic diagram illustrating a curve of an elastic modulus of a sample varying with an angular frequency according to some embodiments of the present disclosure;

FIG. 4 is a schematic diagram illustrating a relationship curve of a flow rate q versus a time t of a sample according to some embodiments of the present disclosure;

FIG. 5 is a schematic diagram illustrating a relationship curve of a stress σ versus a time t of a sample according to some embodiments of the present disclosure.

### DETAILED DESCRIPTION

To more clearly illustrate the technical solutions in the embodiments of the present disclosure, the drawings used in the description of the embodiments will be briefly introduced below. Obviously, the drawings in the following description are merely some examples or embodiments of the present disclosure. For a person of ordinary skill in the art, the present disclosure may be applied to other similar scenarios based on these drawings without creative effort. Unless obviously obtained from the context or the context illustrates otherwise, the same numeral in the drawings refers to the same structure or operation.

It should be understood that the terms “system”, “apparatus”, “unit”, and/or “module” used herein are methods for distinguishing components, elements, parts, sections, or assemblies of different levels. However, if other words can achieve the same purpose, the words may be replaced by other expressions.

As shown in the present disclosure and the claims, unless the context clearly indicates an exception, words such as “a”, “an”, “one”, and/or “the” are not limited to the singular form and may also include the plural form. Generally, the terms “include” and “comprise” only suggest the inclusion of explicitly identified steps and elements. These steps and elements do not constitute an exclusive list. A method or device may also contain other steps or elements.

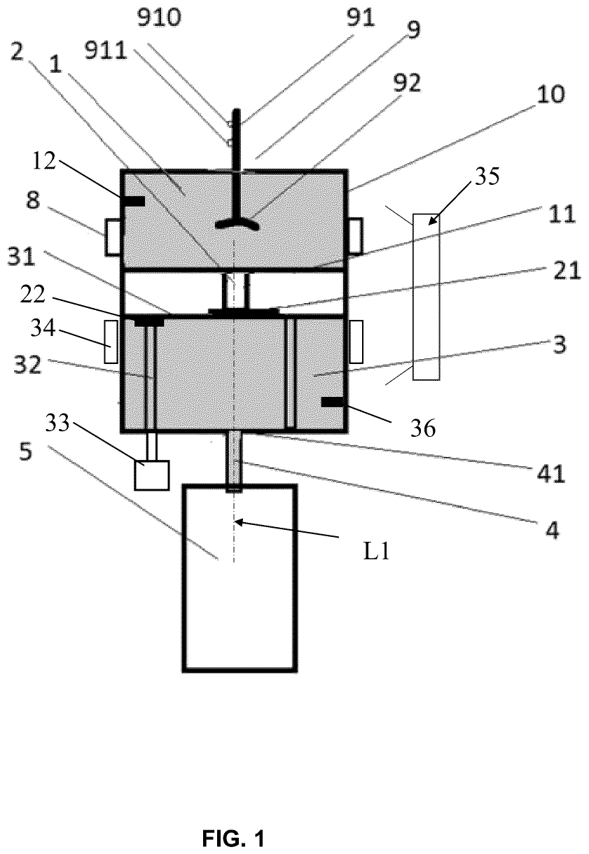

FIG. 1 is a schematic diagram illustrating a structure of a rheometer according to some embodiments of the present disclosure.

A rheometer refers to an instrument used to measure rheological properties of a material (e.g., viscosity, elasticity, plasticity, etc.). The rheometer can monitor a deformation response of the material to obtain rheological parameters of the material during flow and deformation. The rheological parameters refer to a quantitative indicator describing the rheological properties of a material. The rheological parameters include viscosity, elastic modulus, complex viscosity, shear stress, shear rate, normal stress, etc.

A thermosetting resin refers to a resin that undergoes a chemical cross-linking reaction under heat or other specific conditions (e.g., adding a curing agent, light irradiation, etc.), thereby producing cross-linking, volume expansion, or foaming phenomena (hereinafter collectively referred to as expansion). For example, thermosetting resins include phenolic resin, epoxy resin, unsaturated polyester resin, polyurethane resin, etc.

In some embodiments, a rheometer suitable for a thermosetting resin (hereinafter referred to as the rheometer) includes a housing 10, a first piston cylinder 1 disposed inside the housing 10, and a second piston cylinder 3 connected to the first piston cylinder 1 via a connecting rod 2. A capillary tube 4 is mounted at a middle portion of a bottom of the second piston cylinder 3. A container 5 is mounted at an outlet of the capillary tube 4.

A lower end of the first piston cylinder 1 is provided with an upper piston 11. An upper end of the second piston cylinder 3 is provided with a lower piston 31. An upper end of the connecting rod 2 is fixedly connected to the upper piston 11. A lower end of the connecting rod 2 is fixedly connected to the lower piston 31. The connecting rod 2 is configured to drive the lower piston 31 to move downward. A bottom end of the connecting rod 2 is provided with a first force sensor 21 for measuring a first force transmitted from a sample in the first piston cylinder 1 to the lower piston 31.

Both the second piston cylinder 3 and the first piston cylinder 1 are located inside the housing 10. The first piston cylinder 1 is configured to place the sample and provide space for thermal expansion of the sample. The sample is also referred to as a test sample. In some embodiments, the sample is a thermosetting resin. In other embodiments, the sample may be a thermoplastic resin. Thermoplastic resins include polyethylene, polypropylene, polyvinyl chloride, etc.

A solution is contained in the second piston cylinder 3. Hereinafter, the solution may refer to silicone oil. The second piston cylinder 3 is located at a lower end of the first piston cylinder 1. An inlet of the capillary tube 4 communicates with the second piston cylinder 3. An outlet of the capillary tube 4 communicates with the container 5. The upper piston 11, the connecting rod 2, and the lower piston 31 are connected as a whole. The whole may move downward when the sample expands due to heat. After the lower piston 31 moves downward, the solution is squeezed by the lower piston 31 and flows from the capillary tube 4 into the container 5. The rheometer can determine the rheological parameters of the sample by measuring a mass or a flow rate of the solution flowing into the container 5. Hereinafter, the whole composed of the upper piston 11, the connecting rod 2, and the lower piston 31 is also referred to as a piston assembly.

The first force sensor 21 may include a force sensor of the strain gauge type. The first force sensor 21 may also be disposed at a bottom of the first piston cylinder 1 or at a top of the upper piston 11.

The sample may be a thermosetting resin or a foamable material. The solution may include silicone oil, mineral oil, water, low molecular weight alcohol, or the like. Since the silicone oil generally does not require heating, it can be controlled at room temperature. However, the sample in the first piston cylinder 1 needs to be heated to cure or foam and expand. Therefore, separating the two piston cylinders by the connecting rod 2 facilitates independent temperature control for each of the piston cylinders.

In some embodiments, the upper piston and the lower piston are configured to slide in a vertical direction within the first piston cylinder 1 and the second piston cylinder 3, respectively. The vertical direction is the up-down direction.

It should be noted that “upper end” and “lower end” may be defined with reference to the direction of gravity. The direction from the “upper end” to the “lower end” is the direction of gravity. “Upper end” and “lower end” denote endpoints, end faces, ends, portions near the ends, and portions having a certain length of components of the rheometer. The upper end may also be referred to as a top end, a top, or an upper layer. The lower end may also be referred to as a bottom end, a bottom, or a lower layer.

A flow sensor 41 is mounted at an inlet connecting the capillary tube 4 to the bottom of the second piston cylinder 3. The flow sensor 41 is configured to measure a flow rate of the solution extruded from the capillary tube 4. A rotating element 9 is mounted inside the first piston cylinder 1. The rotating element 9 is provided with a torque sensor 910 and a rotational speed sensor 911. The torque sensor 910 is configured to measure a torque of the sample in the first piston cylinder 1 relative to the rotating element 9, and the rotational speed sensor 911 is configured to measure an angular velocity of the rotating element 9. The rheological parameters of the sample during a curing process are determined based on the first force transmitted to the lower piston 31, the flow rate of the solution extruded from the capillary tube 4, the torque, and the angular velocity.

The flow sensor 41 includes a gear flow meter, a volumetric flow meter, or the like. The torque sensor 910 includes a strain gauge torque sensor, an electronic torque meter, or the like. The rotational speed sensor 911 includes a photoelectric encoder, a hall effect rotational speed sensor, or the like.

The rheometer may determine the rheological parameters in various ways. For example, control software may determine the rheological parameters through a preset conversion formula. A technician may construct a preset conversion formula based on geometric dimensions of a rotor, a diameter of the capillary tube, and a length of the capillary tube through rheological principles. Merely by way of example, a shear stress amplitude of the sample equals a torque amplitude divided by a constant related to geometric dimensions of a rotor 92 of the rotating element 9. The geometric dimensions of the rotor include a shape, a radius, and a thickness of the rotor, etc.

The rheometer provided in the present disclosure accounts for volume expansion during curing or foaming of the sample and is improved on the basis of a conventional rotational rheometer. The rheometer provided in the present disclosure is also suitable for measuring rheological parameters of a thermoplastic resin. When the sample is the thermoplastic resin, a normal stress difference (i.e., axial thrust) caused by sample elasticity pushes the lower piston, thereby extruding the solution (e.g., silicone oil) from the capillary tube. The amount of extruded solution reflects elasticity of the sample in shear flow. Termination of a measurement process for a general rheometer leads to an inability to obtain the rheological parameters for an entire process of curing or foaming of the sample completely and accurately. The rheometer provided in the present disclosure can continuously record the rheological parameters during a curing process of the resin, thereby expanding a measurement range and optimizing measurement results.

In some embodiments, the rotating element 9 includes a rotating shaft 91 and the rotor 92 mounted at a lower end of the rotating shaft 91. The rotating element 9 is configured to perform rotational shearing on the sample. A torque sensor 910 and a rotational speed sensor 911 are mounted on the rotating shaft 91 respectively for measuring the torque and the angular velocity generated by the rotor 92. An upper end of the rotating shaft 91 is connected to an electric motor.

The rotor 92 is mounted at a lower end of the rotating shaft 91. The rotating shaft 91 is controlled by the electric motor. Both the rotating shaft 91 and the rotor 92 may perform rotational shearing on the sample. The torque sensor 910 and the rotational speed sensor 911 are mounted on the rotating shaft 91 and measure a torque of the sample on the rotor 92 and the angular velocity of the rotor 92, respectively. The rheological parameters of the sample, such as viscosity or elastic modulus, can then be determined based on the obtained torque and the angular velocity.

In some embodiments, the rotor 92 is a single rotor. A material of the rotor 92 is stainless steel or copper. The rotor 92 is the single rotor, unlike two parallel plate fixtures with a fixed spacing typically found in conventional rotational rheometers. This design effectively prevents the situation where the expanded sample jams a parallel plate fixture, hindering the sample removal. It also avoids the situation where sample expansion exerts an outward thrust on the fixture, causing potentially damage to the fixture. The material of the rotor 92 may be stainless steel, copper, or the like. A surface of the rotor 92 may be treated for rust prevention and anti-sticking to facilitate cleaning.

The rotating shaft 91 is fixedly connected to the rotor 92. The electric motor may drive both the rotating shaft 91 and the rotor 92 to rotate simultaneously. The electric motor includes a servo motor, a direct current (DC) motor, or the like.

In some embodiments, a top of the first piston cylinder 1 is detachably fixed to the housing 10 to facilitate removal of the sample after measurement.

In some embodiments, output ends of the torque sensor, the rotational speed sensor, the first force sensor, the flow sensor, and the temperature sensor are connected to input ends of an external control software (hereinafter referred to as control software).

By connecting the output ends of the torque sensor and the rotational speed sensor to the input ends of the control software, the control software can directly generate a complex viscosity-angular frequency rheological curve and an elastic modulus versus angular frequency curve of the sample to be tested based on data output from the torque sensor and the rotational speed sensor. The control software may be designed with various preset conversion formulas to determine the rheological parameters of the sample to be tested.

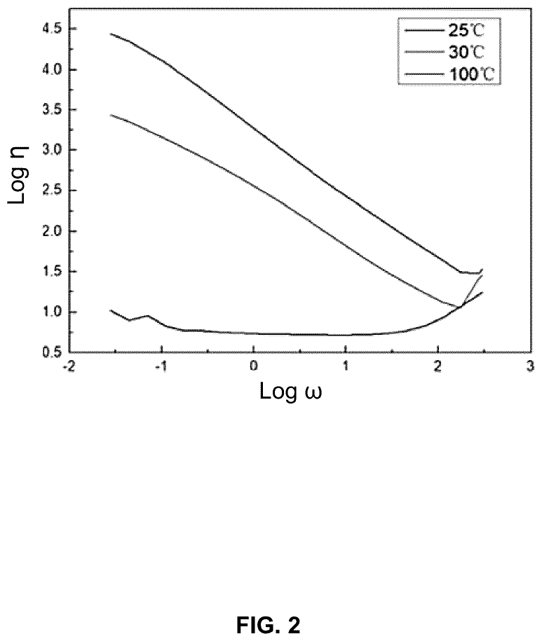

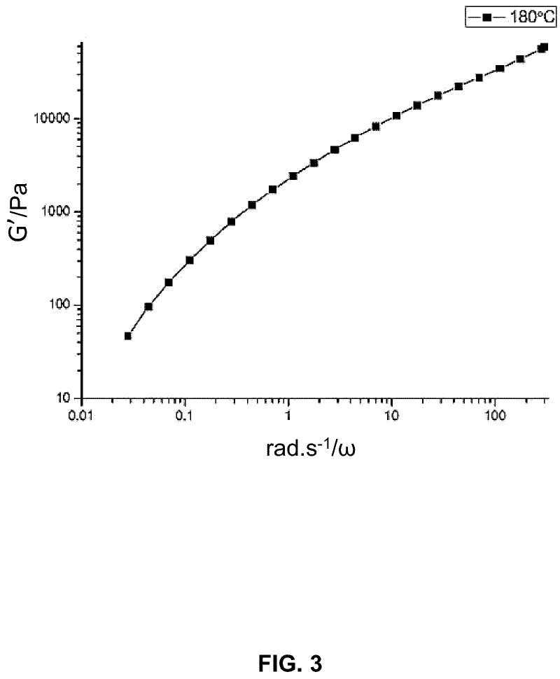

FIG. 2 is a schematic diagram illustrating a viscosity-angular frequency rheological curve of a sample according to some embodiments of the present disclosure. FIG. 3 is a schematic diagram illustrating a curve of an elastic modulus of a sample varying with an angular frequency according to some embodiments of the present disclosure. In FIGS. 2 and 3, η represents viscosity, w represents an angular velocity, and G′ represents an elastic modulus. As shown in FIGS. 2 and 3, taking a sample of phenolic resin liquid 2130+curing agent (50/50) as an example, by inputting the torque of the rotor 92 and the angular velocity of the rotor 92 obtained by the torque sensor and the rotational speed sensor to the input ends of the external control software, the external control software automatically generates the complex viscosity-angular frequency rheological curve and the elastic modulus versus angular frequency curve as shown in FIGS. 2 and 3. Based on FIGS. 2 and 3, it can be clearly seen that at a lower temperature, e.g., 25° C., the phenolic resin liquid exhibits Newtonian fluid properties and does not undergo shear thinning with increasing angular frequency. However, when the temperature rises to 30° C. or 100° C., it exhibits significant non-Newtonian fluid shear-thinning properties. When the angular frequency reaches 100 rad/s, the viscosity shows an increasing trend, indicating that the sample begins to cure and cross-link. When the temperature reaches 180° C., the elastic modulus increases with increasing angular frequency.

In some embodiments, the first piston cylinder 1, the connecting rod 2, the second piston cylinder 3, and the capillary tube 4 are all cylindrical bodies. Central axes of the cylindrical bodies of the first piston cylinder 1, the connecting rod 2, the second piston cylinder 3, and the capillary tube 4 are on a same vertical line. The rotating element 9 is also disposed on an extension of the vertical line. As shown in FIG. 1, the central axes of the first piston cylinder 1, the connecting rod 2, the second piston cylinder 3, and the capillary tube 4 are all L1.

In some embodiments, the upper piston 11 is positioned at the lower end of the sample. The upper piston 11 and the lower piston 31 are connected by the connecting rod 2. A first force sensor 21 is mounted at the bottom end of the connecting rod 2, configured to measure a first force transmitted to the lower piston 31 due to sample expansion. The upper piston 11 and the lower piston 31 may slide freely within the first piston cylinder 1 and the second piston cylinder 3, respectively.

In some embodiments, a diameter of the capillary tube 4 is within a range of 0.5 mm-1.5 mm. In some embodiments, the diameter of the capillary tube 4 is 0.5 mm, 1 mm, and 1.5 mm. Because the diameter of the capillary tube is small, a slight movement of the lower piston 31 in the second piston cylinder 3 presses the internal silicone oil to be extruded from the capillary tube 4. The extruded flow rate is sensitive to the expansion process of the sample, which is beneficial for improving measurement accuracy. The first force acquired by the first force sensor 21 (which is transmitted to the lower piston 31 due to sample expansion) and the flow rate of the silicone oil extruded from the capillary tube 4 (as measured by the flow sensor 41) are input into the external control software. The external control software may then directly generate a stress o-time t curve and a flow rate q-time t curve based on these inputs.

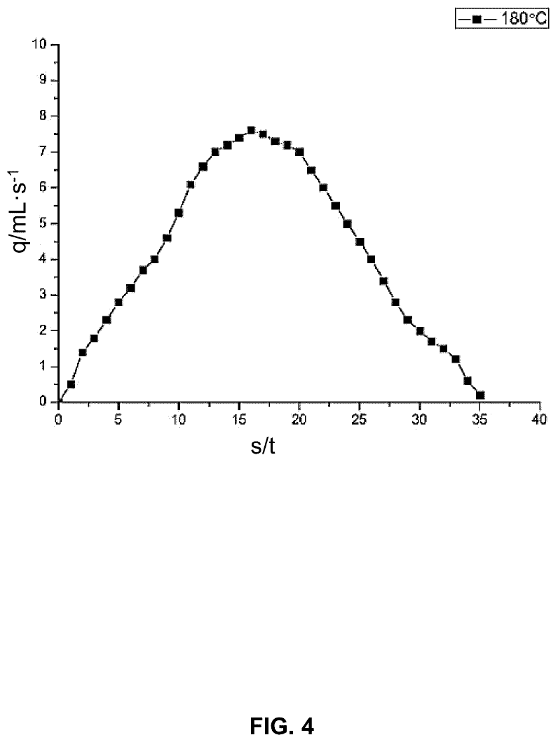

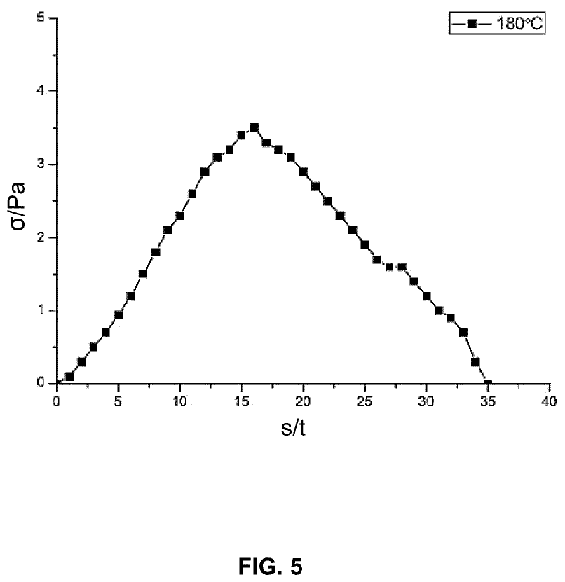

FIG. 4 is a schematic diagram illustrating a relationship curve of a flow rate q versus a time t of a sample according to some embodiments of the present disclosure. FIG. 5 is a schematic diagram illustrating a relationship curve of a stress σ versus a time t of a sample according to some embodiments of the present disclosure. As shown in FIGS. 4 and 5, at a fixed strain of 4%, a constant angular frequency of 0.1 rad/s, and a temperature of 180° C., the flow rate of silicone oil extruded from the capillary tube 4 first increases and then decreases over time. The stress-time curve measured by the first force sensor 21 also shows a similar trend. This indicates that the sample gradually cures and cross-links as the time progresses. Upon completion of curing, the flow rate or stress gradually decreases to zero. FIGS. 4 and 5 show that a curing time of the phenolic resin liquid sample is about 35 seconds.

In some embodiments, as shown in FIG. 1, a telescopic support rod 32 is provided inside the second piston cylinder 3. An upper end of the telescopic support rod 32 is fixedly connected to the lower piston 31. A lower end of the telescopic support rod 32 is fixedly connected to a bottom surface inside the second piston cylinder 3. The telescopic support rod 32 refers to a rod member that can contract under pressure. The telescopic support rod 32 may be a spring or a gas spring.

To prevent the upper piston and the lower piston from moving downward due to gravity, the telescopic support rod 32 is used to balance a gravity of the piston assembly (i.e., the upper piston 11, the connecting rod 2, and the lower piston 31), achieving a force balance state. This can ensure that the upper piston 11 and the lower piston 31 do not move before a measurement starts. An atmospheric pressure force is capable of overcoming a gravity of silicone oil in the second piston cylinder 3. When the piston does not move, the silicone oil in the second piston cylinder 3 does not flow out from the capillary tube 4. When the lower piston 31 moves downward, the silicone oil is squeezed and is capable of flowing out from the capillary tube 4. A force balance state refers to a state where a resultant force on the piston assembly is zero and the piston assembly remains stationary.

In some embodiments, as shown in FIG. 1, the telescopic support rod 32 is an active telescopic rod. A second force sensor 22 is provided at a contact position between the active telescopic rod and the lower piston 31, and the second force sensor 22 is configured to acquire a second force applied by the active telescopic rod to the lower piston 31.

The active telescopic rod refers to a support rod capable of actively telescoping. The active telescopic rod includes a first driving device 33. The first driving device 33 is disposed at a bottom of the active telescopic rod. The first driving device 33 is a device capable of driving the active telescopic rod to perform a reciprocating motion. Merely by way of example, the first driving device 33 includes a pneumatic cylinder, a hydraulic cylinder, a linear motor, an electric push rod, etc.

The second force can reflect a supporting force of the active telescopic rod on the lower piston 31. In some embodiments, when no sample is loaded, the active telescopic rod can continuously detect the second force by adjusting operating parameters until the piston assembly is in the force balance state. More descriptions regarding the active telescopic rod may be found in the related descriptions below.

As a count of use of the telescopic support rod 32 increases, its supporting performance may decline, which may negatively affect measurement accuracy and stability of the rheometer. By replacing the telescopic support rod 32 with the active telescopic rod, the piston assembly is ensured to be in the force balance state before the measurement starts. This enables measurement of a weight or a flow rate of the silicone oil conforming to real rheological parameters after the measurement starts.

In some embodiments, a temperature sensor 12 is provided inside the first piston cylinder 1. The temperature sensor 12 is configured to measure a sample temperature of the sample inside the first piston cylinder 1. The sample temperature may also refer to a heating temperature of the sample. A heating element 8 is mounted outside the first piston cylinder 1.

The temperature sensor 12 includes a thermocouple. The heating element 8 includes a resistance heating tube.

Before measuring, the sample is loaded in the first piston cylinder 1. The first piston cylinder 1 is heated by the heating element 8 and its temperature is controlled according to the sample temperature from the temperature sensor 12. At a certain temperature, the rheological parameters such as the viscosity and the elastic modulus of the sample may be measured and obtained by the torque sensor 910 and the rotational speed sensor 911.

In some embodiments, silicone oil extruded from the capillary tube 4 flows into a container 5. The container 5 is used to collect the silicone oil, so that the silicone oil can be reused.

In some embodiments, the viscosity of the sample changes with temperature and time. As the viscosity of the sample increases, the fluidity of the sample may deteriorate, but the volume expansion of the sample will cause the silicone oil to be extruded. More intense expansion results in a higher extrusion speed of the silicone oil. Thus, the silicone oil extrusion speed-time curve is an indirect characterization of the expansion of the sample. When the viscosity of the sample increases too much, the rotor may become difficult to operate effectively. At this point, the flow behavior of the low-viscosity silicone oil can provide supplementary characterization of the sample's curing and expansion. That is, the curing and expansion of the sample may be indirectly determined by observing the flow behavior of the low-viscosity silicone oil. For example, the viscosity of the sample increases due to expansion and curing, while the expansion concurrently causes an increase in the extrusion speed of the silicone oil. The extrusion speed and the flow rate of the silicone oil are proportional to the change in the viscosity of the sample. In some embodiments, the rotating element is further provided with a self-protection device. When the torque exceeds a preset torque range, the self-protection device stops rotation to protect the rotating shaft and the rotor.

In some embodiments, the first piston cylinder 1 may be made of a transparent material or the first piston cylinder 1 may be made by mounting a transparent window on a stainless steel cylinder body, to facilitate visual monitoring of a curing or foaming process of the sample.

The rheometer provided by some embodiments of the present disclosure can measure the torque of the sample on the rotor 92 and the angular velocity of the rotor 92, respectively, via the torque sensor 910 and the rotational speed sensor 911 mounted on the rotating shaft 91, further allowing for obtaining the viscosity and elastic modulus of the sample during its curing or foaming process. The first force sensor 21, mounted at the bottom end of the connecting rod 2, measures the force transmitted to the lower piston 31 by the expansion of the test sample, thereby determining the force generated by sample expansion or foaming. Simultaneously, the flow sensor 41, located at the bottom of the second piston cylinder 3, measures the flow rate of the solution extruded from the capillary tube 4, which in turn provides a flow rate vs. time curve for the extruded silicone oil. The force-time curve and the flow rate-time curve are used to characterize the kinetics of the curing, cross-linking, or foaming process of a sample. Together with rheological parameter curves, such as viscosity and elastic modulus obtained using the rotor, the force-time curve and the flow rate-time curve comprehensively characterize the kinetic process of the curing, cross-linking, or foaming of the sample.

In some embodiments of the present disclosure, the rheometer considers volume expansion of the sample during curing or foaming and is improved based on a traditional rotational rheometer. The rheometer provided by some embodiments of the present disclosure is controlled by control software. Experimental data and curves can be recorded and processed by the control software. The rheometer provided by some embodiments of the present disclosure combines the advantages of a rotational rheometer and a capillary rheometer. However, what is extruded from the capillary tube is not the test sample, but low-viscosity silicone oil. The extrusion amount of the silicone oil can indirectly characterize the curing, cross-linking, or foaming process of the test sample.

In some embodiments, the rheometer further includes a processor, a thermostatic device 34, and an image acquisition device 35. The thermostatic device 34 is movably disposed outside the second piston cylinder and is configured to control the solution temperature of the solution inside the second piston cylinder.

The processor is configured to receive and analyze data from the rheometer. The processor may include, but is not limited to, a central processing unit (CPU), a graphics processing unit (GPU), etc. The processor may be part of the system that hosts the control software. The control software may be disposed on a computer of the technician.

The thermostatic device 34 refers to a device used to control the solution temperature. The thermostatic device 34 may include a heating component and a cooling component. The heating component is similar to the heating element 8. The cooling component includes a water cooling pipe, a refrigerator, etc. The thermostatic device 34 may be disposed outside the second piston cylinder 3, wrapping around a part of the second piston cylinder 3.

The thermostatic device 34 may be movably disposed outside the second piston cylinder via a second driving device. A structure of the second driving device is similar to the first driving device 33. The second driving device is capable of driving the thermostatic device 34 to move up-and-down reciprocally.

In some embodiments, a solution temperature sensor 36 may further be disposed in the second piston cylinder 3. The solution temperature sensor 36 is configured to obtain the solution temperature of the solution inside the second piston cylinder. A structure of the solution temperature sensor 36 is similar to the temperature sensor 12. In some embodiments, the processor is configured to adjust the thermostatic device based on the solution temperature, thereby keeping the solution temperature within a preset temperature range. The processor may adjust the heating or cooling power of the thermostatic device based on a Proportional-Integral-Derivative Controller (PID) or other closed-loop control algorithms, so that the temperature of the solution is within a preset temperature range. For example, the temperature of the silicone oil is within the room temperature. A manner in which the processor adjusts the sample temperature is similar to the manner of adjusting the solution temperature.

The thermostatic device may maintain the temperature of the silicone oil, so that the temperature of the silicone oil is within the preset range. This facilitates ensuring that the silicone oil does not evaporate due to heat, leak, etc. This avoids affecting a flow rate extruded through the capillary tube 4, and further avoids affecting an accuracy of a reading of the flow sensor 41.

When the lower piston moves, the thermostatic device 34 moves along with it. This can ensure that the thermostatic device 34 always maintains a relative position with the lower piston 31. This avoids affecting the sample temperature of the first piston cylinder 1 due to a distance change. The thermostatic device 34 is movably disposed outside the second piston cylinder. This enables precise temperature control and improves a measurement accuracy of the rheometer.

In some embodiments, a first transparent window and a second transparent window are provided on the first piston cylinder and the second piston cylinder, respectively. The image acquisition device 35 is disposed outside the first piston cylinder 1 and the second piston cylinder 3. The image acquisition device 35 is configured to acquire first image data of the first transparent window and second image data of the second transparent window.

The image acquisition device 35 includes a camera, a camcorder, etc. The housing 10 may be made of a transparent material (e.g., glass, a transparent acrylic plate). Alternatively, the housing 10 is made of a stainless steel material. The first transparent window and the second transparent window are disposed on the housing 10. The first transparent window may cover a movement range of the upper piston 11. The second transparent window may cover a movement range of the lower piston 31. This allows the image acquisition device 35 to acquire valid images.

The first image data may characterize an adhesion feature of the sample and a position of the upper piston 11. The adhesion feature of the sample refers to a situation where, after the sample expands, a portion of the sample adheres to the first transparent window. The second image data may characterize a position of the lower piston 31.

In some embodiments, the processor is configured to: determine movement information of the lower piston based on the second image data; determine movement parameters of the thermostatic device based on the movement information of the lower piston 31; and control the thermostatic device to move based on the movement parameters.

The movement information of the lower piston 31 refers to a distance that the lower piston 31 is driven to move by expansion of the sample. The movement information includes a sequence composed of a plurality of movement distances.

The movement parameters of the thermostatic device include a movement distance of the thermostatic device, a movement speed of the thermostatic device, etc.

It is understandable that the first force, the second force, the movement information of the lower piston 31, the sample temperature, the solution temperature, etc., are all sequence data.

The processor may determine the movement information of the lower piston based on the second image data via an image recognition algorithm. Merely by way of example, the processor may perform feature extraction on the second image data based on edge detection algorithms such as Canny, Sobel, and Prewitt, or corner detection algorithms such as Harris and Shi-Tomasi to obtain pixels associated with the lower piston and record their coordinates. The processor may then convert these pixel coordinates into an actual physical distance using a conversion algorithm, for instance, one based on a pixel-to-millimeter conversion coefficient, thereby determining the movement information of the lower piston.

The processor may determine the movement parameters of the thermostatic device based on the movement information of the lower piston 31 via a first preset table. The first preset table includes a correspondence between the movement information of the lower piston 31 and the movement parameters of the thermostatic device. Merely by way of example, the first preset table may be constructed by setting the moving distance or moving speed of the lower piston 31 to the moving distance or moving speed of the thermostatic device; that is, the thermostatic device and the lower piston 31 move synchronously.

In some embodiments, the upper piston, the connecting rod, and the lower piston form the piston assembly. The processor is further configured to: when no sample is loaded, control the active telescopic rod to drive the lower piston to perform reciprocating up-and-down motion, and acquire the first force and the second force; determine a first non-expansive force based on a net gravity of the piston assembly, displacement and velocity data of the active telescopic rod, the first force, and the second force; and correct the first force acquired after the measurement starts based on the first non-expansive force. More descriptions regarding the active telescopic rod, the first force, and the second force may be found in the related descriptions above.

The net gravity of the piston assembly refers to a theoretical gravity of the piston assembly composed of the upper piston 11, the connecting rod 2, and the lower piston 31. The net gravity of the piston assembly may be input by the technician. For example, the technician may completely disassemble the piston assembly and perform precise weighing during installation or regular maintenance to obtain the net gravity of the piston assembly.

The displacement and velocity data of the active telescopic rod refer to the displacement and velocity data of the active telescopic rod during the reciprocating up-and-down motion. The displacement and velocity data of the active telescopic rod may be directly acquired from the first driving device 33.

The first non-expansive force refers to other forces that affect a reading of the first force sensor 21, besides a force generated by expansion of the sample itself. The first non-expansive force may include a friction force between the upper piston and the first piston cylinder, a friction force between the lower piston and the second piston cylinder, a fluid resistance, a stress caused by temperature changes, etc.

When no sample is loaded, the processor may control the active telescopic rod to drive the lower piston to perform reciprocating up-and-down motion at different constant speeds and acquire the first force detected by the first force sensor 21 and the second force detected by the second force sensor 22.

In some embodiments, the processor may determine the first non-expansive force through a preset calculation formula based on the net gravity of the piston assembly, the displacement and velocity data of the active telescopic rod, the first force, and the second force. The preset calculation formula is constructed by the technician based on a force balance equation. Merely by way of example, the preset calculation formula is as follows: when the acceleration (derived from the displacement and velocity data of the active telescopic rod) is 0, the equation is: the second force (upward)+the first non-expansive force (upward)—the net gravity of the piston assembly (downward)−the first force (downward)=K. K is a constant. Upward and downward indicate directions of the forces. A positive value of a force indicates a downward acting force, and a negative value indicates an upward acting force. A final first non-expansive force may be an average or a median of a plurality of first non-expansive forces obtained according to the foregoing preset calculation formula.

In some embodiments, after the first non-expansive force is determined and the measurement starts, the processor corrects the first force acquired after the measurement starts based on the first non-expansive force. For example, after the measurement starts, the processor may subtract the first non-expansive force from the first force detected by the first force sensor 21, thereby obtaining the corrected first force acquired after the measurement starts. If the first force is sequence data including a plurality of values, the first non-expansive force may be subtracted from each value.

Due to the existence of the first non-expansive force, the reading of the first force sensor 21 does not completely characterize the expansion force of the sample. By determining the first non-expansive force before each measurement to correct the first force acquired after the measurement starts, more accurate rheological parameters can be obtained.

In some embodiments, the processor is further configured to: when no sample is loaded, adjust the operating parameters of the active telescopic rod based on the first force and the second force.

The operating parameters of the active telescopic rod refer to parameters that controls operation of the active telescopic rod. The operating parameters include a length of the active telescopic rod. The first driving device 33 operates the active telescopic rod based on the operating parameters. For example, the first driving device 33 may drive the active telescopic rod to extend or retract, so that the length of the active telescopic rod matches the operating parameters.

In some embodiments, the processor adjusts the operating parameters of the active telescopic rod based on the first force and the second force in a plurality of ways. For example, the processor may determine a difference between the first force and the second force based on the first force and the second force. The processor may determine the operating parameters of the active telescopic rod based on the difference via a second preset table. The second preset table includes a correspondence relationship between the difference and the operating parameters of the active telescopic rod. Merely by way of example, the second preset table may be constructed in the following manner. When no sample is loaded, the first force and the second force are measured when the piston assembly is in a force balance state with silicone oil of different grades or different volumes. The difference between the first force and the second force is calculated. The operating parameters of the active telescopic rod at this time are the operating parameters of the active telescopic rod corresponding to the difference, for entry into the second preset table.

Without loading the sample, the active telescopic rod may continuously adjust the operating parameters. The active telescopic rod may continuously detect the first force and the second force until the piston assembly is in the force balance state.

When the silicone oil has different grades or different volumes, the length of the active telescopic rod required for the piston assembly to be in the force balance state is not completely the same. If the length of the active telescopic rod cannot be precisely controlled, the weight of the silicone oil flowing into the container 5 is inaccurate.

In some embodiments, after the measurement starts, the processor is further configured to determine an adhesion feature based on the first image data. The processor is further configured to determine a second non-expansive force through a compensation model based on the first non-expansive force, the movement information of the lower piston, the sample temperature, the solution temperature, the operating parameters of the active telescopic rod, the adhesion feature, and historical operation data. The compensation model is a machine learning model. The processor is further configured to correct the first force acquired after the measurement starts based on the second non-expansive force. More descriptions regarding the first image data, the first non-expansive force, the movement information of the lower piston, the sample temperature, the solution temperature, and the operating parameters of the active telescopic rod may be found in the related descriptions above.

The adhesion feature refers to an area where the sample adheres to the first piston cylinder and the upper piston after the sample expands. When the adhesion feature changes, the detected first force may be affected. For example, adhesion of a part of the sample to the first piston cylinder and/or the upper piston may increase a friction force between the sample and the first piston cylinder and a friction force between the upper piston and the first piston cylinder.

The processor may determine the adhesion feature based on the first image data via an image recognition algorithm. More descriptions regarding determination of the adhesion feature via the image recognition algorithm is similar to descriptions of determining the movement information of the lower piston via the image recognition algorithm, please refer to the foregoing description.

The historical operation data refers to state or operation record information of the rheometer during past operation. For example, the historical operation data includes a cumulative count of measurements, a cumulative moving distance of the piston assembly, a historical sample temperature, a historical solution temperature, etc. The historical operation data may be directly acquired by the processor.

A meaning of the second non-expansive force is the same as a meaning of the first non-expansive force. A difference is that the second non-expansive force is obtained after considering more factors. The second non-expansive force is a sequence corresponding to the sequence of the first force.

In some embodiments, the compensation model is a machine learning model. In some embodiments, the compensation model is a recurrent neural network (RNN) model. The compensation model may also be another model, e.g., a machine learning model with a custom structure.

In some embodiments, an input of the compensation model may include the first non-expansive force, the movement information of the lower piston, the sample temperature, the solution temperature, the operating parameters of the active telescopic rod, the adhesion feature, and the historical operation data. An output of the compensation model is the second non-expansive force.

In some embodiments, the compensation model may be obtained via training based on a plurality of training samples with labels. In some embodiments, each of the training samples may at least include a sample first non-expansive force, sample movement information of the lower piston, a sample temperature, a sample solution temperature, sample operating parameters of the active telescopic rod, a sample adhesion feature, and sample historical operation data. A label of a training sample may be the second non-expansive force corresponding to the training sample. The training samples may be experimental data.

In some embodiments, known volume expansion force data corresponding to different samples is acquired. Experiments are performed on the rheometer with different samples, different sample temperatures, different solution temperatures, or different operating parameters of the active telescopic rod. The label is determined based on a force balance equation. Merely by way of example, the technician may perform a control experiment using two types of samples. A type 1 sample is a standard liquid that does not cure and does not foam (e.g., silicone oil). A type 2 sample is a sample with a known volume expansion force (e.g., a thermosetting resin). The known volume expansion force of the type 2 sample may be acquired in advance using a dilatometer, a pressure-volume-temperature analyzer (PVT analyzer), etc. The labels for type 1 and type 2 samples after experiments may be determined based on the force balance equation. For example, the label is determined by subtracting the net gravity of the sample, the first non-expansive force, the oil resistance force, and the known volume expansion force from the total force measured by the sensor.

In some embodiments, the compensation model may be trained based on the foregoing training samples via various methods to update model parameters. For example, the training may be performed based on a gradient descent method. In some embodiments, the training ends when the trained compensation model satisfies a preset condition. The preset condition may be that a result of a loss function converges or is less than a preset threshold, etc.

The way in which the processor corrects the first force acquired after the measurement starts based on the second non-expansive force is similar to the way of correcting the first force based on the first non-expansive force. A difference is that the second non-expansive force is a is a time-point-based sequence. Each time point corresponds to a time point of the first force. The processor may correct the first force acquired after the measurement starts based on the second non-expansive force at a time point corresponding to the first force.

A friction force between the sample and the wall of the first piston cylinder, a friction force at various positions of the rheometer, temperature, a resistance characteristic of the solution, etc., may cause an additional resistance. The additional resistance causes a reading of the first force sensor not to be completely equivalent to the expansion force of the sample, or the reading of the first force sensor exhibits hysteresis. The second non-expansive force may be determined via the machine learning model, thereby compensating for the first force detected by the first force sensor and enabling the first force to more accurately reflect the real rheological situation of the sample.

The foregoing description has described basic concepts. Obviously, to a person skilled in the art, the foregoing detailed disclosure is merely an example and does not constitute a limitation to the present disclosure. Although not explicitly stated herein, the person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, an order of processing elements and sequences, use of numbers and letters, or use of other names in the present disclosure is not used to limit an order of processes and methods of the present disclosure. Although the foregoing disclosure discusses some inventive embodiments currently considered useful through various examples, it should be understood that such details are for illustrative purposes only. The appended claims are not limited to the disclosed embodiments. Instead, the claims are intended to cover all amendments and equivalent combinations that conform to the substance and scope of the embodiments of the present disclosure. For example, although the implementation of various components described above may be embodied in a hardware device, it may also be implemented as a software only solution, e.g., an installation on an existing server or mobile device.

Similarly, it should be noted that, to simplify the description in the present disclosure and thereby facilitate an understanding of one or more embodiments of the invention, various features are sometimes grouped into a single embodiment, figure, or description thereof in the foregoing description of the embodiments of the present disclosure. However, this method of disclosure does not imply that the object of the present disclosure requires more features than those recited in the claims. Rather, the claimed subject matter may lie in less than all features of a single foregoing disclosed embodiment.

Finally, it should be understood that the embodiments described in the present disclosure are merely intended to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A rheometer suitable for a thermosetting resin, comprising: a housing, a first piston cylinder disposed inside the housing, and a second piston cylinder connected to the first piston cylinder via a connecting rod; wherein
a capillary tube is mounted at a middle portion of a bottom of the second piston cylinder, and a container is mounted at an outlet of the capillary tube; a lower end of the first piston cylinder is provided with an upper piston, and an upper end of the second piston cylinder is provided with a lower piston;
an upper end of the connecting rod is fixedly connected to the upper piston, and a lower end of the connecting rod is fixedly connected to the lower piston, wherein the connecting rod is configured to drive the lower piston to move downward;
a bottom end of the connecting rod is provided with a first force sensor for measuring a first force transmitted from a sample in the first piston cylinder to the lower piston;
a flow sensor is mounted at an inlet connecting the capillary tube to the bottom of the second piston cylinder, and the flow sensor is configured to measure a flow rate of a solution extruded from the capillary tube;
a rotating element is mounted inside the first piston cylinder, wherein the rotating element is provided with a torque sensor and a rotational speed sensor, the torque sensor is configured to measure a torque of the sample in the first piston cylinder relative to the rotating element, and the rotational speed sensor is configured to measure an angular velocity of the rotating element; and
rheological parameters of the sample during a curing process are determined based on the first force transmitted to the lower piston, the flow rate of the solution extruded from the capillary tube, the torque, and the angular velocity.

2. The rheometer suitable for the thermosetting resin of claim 1, wherein the rotating element comprises a rotating shaft and a rotor mounted at a lower end of the rotating shaft, and the rotating element is configured to perform rotational shearing on the sample.

3. The rheometer suitable for the thermosetting resin of claim 2, wherein the torque sensor and the rotational speed sensor are mounted on the rotating shaft respectively for measuring the torque and the angular velocity generated by the rotor; and an upper end of the rotating shaft is connected to an electric motor.

4. The rheometer suitable for the thermosetting resin of claim 2, wherein the rotor is a single rotor, and a material of the rotor is stainless steel or copper.

5. The rheometer suitable for the thermosetting resin of claim 1, wherein the first piston cylinder, the connecting rod, the second piston cylinder, and the capillary tube are all cylindrical bodies; central axes of the cylindrical bodies of the first piston cylinder, the connecting rod, the second piston cylinder, and the capillary tube are on a same vertical line; and the rotating element is also disposed on an extension of the vertical line.

6. The rheometer suitable for the thermosetting resin of claim 1, wherein a heating element is mounted outside the first piston cylinder.

7. The rheometer suitable for the thermosetting resin of claim 1, wherein the upper piston and the lower piston are configured to slide in a vertical direction within the first piston cylinder and the second piston cylinder, respectively.

8. The rheometer suitable for the thermosetting resin of claim 1, wherein a telescopic support rod is provided inside the second piston cylinder; an upper end of the telescopic support rod is fixedly connected to the lower piston, and a lower end of the telescopic support rod is fixedly connected to a bottom surface inside the second piston cylinder.

9. The rheometer suitable for the thermosetting resin of claim 1, wherein a temperature sensor is provided inside the first piston cylinder for measuring a sample temperature of the sample inside the first piston cylinder.

10. The rheometer suitable for the thermosetting resin of claim 1, wherein output ends of the torque sensor, the rotational speed sensor, the first force sensor, the flow sensor, and the temperature sensor are connected to input ends of an external control software.

11. The rheometer suitable for the thermosetting resin of claim 1, further comprising: a processor, a thermostatic device, and an image acquisition device; wherein
the thermostatic device is movably disposed outside the second piston cylinder and is configured to control a solution temperature of a solution inside the second piston cylinder;
a first transparent window and a second transparent window are provided on the first piston cylinder and the second piston cylinder, respectively; the image acquisition device is disposed outside the first piston cylinder and the second piston cylinder and is configured to acquire first image data of the first transparent window and second image data of the second transparent window; and
the processor is configured to:
determine movement information of the lower piston based on the second image data; and
determine movement parameters of the thermostatic device based on the movement information of the lower piston, and control the thermostatic device to move based on the movement parameters.

12. The rheometer suitable for the thermosetting resin of claim 11, wherein
a telescopic support rod is provided inside the second piston cylinder; an upper end of the telescopic support rod is fixedly connected to the lower piston, and a lower end of the telescopic support rod is fixedly connected to a bottom surface inside the second piston cylinder; wherein the telescopic support rod is an active telescopic rod; and
a second force sensor is provided at a contact position between the active telescopic rod and the lower piston, and the second force sensor is configured to acquire a second force applied by the active telescopic rod to the lower piston.

13. The rheometer suitable for the thermosetting resin of claim 12, wherein
the upper piston, the connecting rod, and the lower piston form a piston assembly;
and the processor is further configured to:
when no sample is loaded, control the active telescopic rod to drive the lower piston to perform reciprocating up-and-down motion, and acquire the first force and the second force; and
determine a first non-expansive force based on a net gravity of the piston assembly, displacement and velocity data of the active telescopic rod, the first force, and the second force; and correct the first force acquired after a measurement starts based on the first non-expansive force.

14. The rheometer suitable for the thermosetting resin of claim 13, wherein the processor is further configured to:
when no sample is loaded, adjust a length of the active telescopic rod based on the first force and the second force.

15. The rheometer suitable for the thermosetting resin of claim 13, wherein the processor is further configured to:
determine an adhesion feature based on the first image data;
determine a second non-expansive force through a compensation model based on the first non-expansive force, the movement information of the lower piston, a sample temperature, the solution temperature, operating parameters of the active telescopic rod, the adhesion feature, and historical operation data; wherein the compensation model is a machine learning model; and
correct the first force acquired after the measurement starts based on the second non-expansive force.
